(19) United States
(12) Patent Application Publication
(10) Pub. No.: US 2016/0163255 A1
(43) Pub. Date: Jun. 9, 2016

(54) ORGANIC LIGHT-EMITTING DISPLAY AND METHOD OF DRIVING THE SAME

(71) Applicant: SAMSUNG DISPLAY CO., LTD., Yongin-City (KR)

(72) Inventors: Bo Yeon Kim, Seoul (KR); Oh Jo Kwon, Suwon-si (KR)

(21) Appl. No.: 14/681,030

(22) Filed: Apr. 7, 2015

(30) Foreign Application Priority Data
Dec. 3, 2014 (KR) 10-2014-0171982

(51) Int. Cl. G09G 3/32; G09G 3/20

(52) U.S. Cl. CPC G09G 3/325; G09G 3/2003; G09G 3/3283; G09G 3/3291; G09G 2300/0819; G09G 2310/0291; G09G 2300/043; G09G 2310/0272; G09G 2310/0297

(57) ABSTRACT

An organic light-emitting display devices includes a display panel having first and second pixel groups, each group including first, second, and third pixels which emit light of different colors and a current measurement unit having a plurality of current measurement channels connected to the first and second pixel groups by data lines, wherein each of the current measurement channels includes a first measurement circuit connected to one of the first, second, and third pixels in the first pixel group and measures current characteristics of the connected one of the pixels and a second measurement circuit which measures current characteristics of one of the first, second, and third pixels, in the second pixel group, which emits light of the same color as that of light emitted from the one of the pixels connected to the first measurement circuit.

### CROSS-REFERENCE TO RELATED APPLICATION

This application claims priority to and the benefit of Korean Patent Application No. 10-2014-0171982 filed on Dec. 3, 2014 in the Korean Intellectual Property Office, the disclosure of which is incorporated herein by reference in its entirety.

### BACKGROUND

1. Field

Embodiments of the present invention relate to an organic light-emitting display and a method of driving the same.

2. Description of the Related Art

An organic light-emitting display, which is drawing attention as a next-generation display, displays an image using organic light-emitting diodes which emit light by recombination of electrons and holes. The organic light-emitting display has features of high response speed, high luminance, a wide viewing angle, and low power consumption.

The organic light-emitting display controls the amount of current provided to the organic light-emitting diodes using a driving transistor included in each pixel and generates light having specific luminance according to the amount of current provided to the organic light-emitting diode.

The organic light-emitting diode is degraded in proportion to the duration of use, thereby reducing display luminance. In particular, there occurs a luminance difference between pixels due to a difference in characteristics such as a threshold voltage (Vth) of the driving transistor and the degradation of the organic light-emitting diode. If the luminance imbalance worsens, an image sticking phenomenon may occur, resulting in reduced image quality. To determine the degree of degradation of the organic light-emitting diode, characteristics of both a pixel circuit and the organic light-emitting diode should be measured and stored. To this end, a relatively large memory corresponding to the number of pixels included in a display panel is required, and high processing speed is also required.

### SUMMARY

Embodiments of the present invention provide an organic light-emitting display which can accurately measure an electric current of each pixel using a simple structure and relatively reduce a memory size.

Embodiments of the present invention also provide a method of driving an organic light-emitting display which can accurately measure an electric current of each pixel using a simple structure and reduce a memory size.

However, the present invention is not limited to the embodiments set forth herein. The above and other aspects of the embodiments of the present invention will become more apparent to one of ordinary skill in the art to which embodiments of the present invention pertains by referencing the detailed description of the present invention given below.

According to embodiments of the present invention, an organic light-emitting display includes a display panel having first and second pixel groups, each group including first, second, and third pixels which emit light of different colors and a current measurement unit having a plurality of current measurement channels connected to the first and second pixel groups by data lines, wherein each of the current measurement channels includes a first measurement circuit connected to one of the first, second, and third pixels in the first pixel group and measures current characteristics of the connected one of the pixels and a second measurement circuit which measures current characteristics of one of first, second, and third pixels, in the second pixel group, which emits light of the same color as that of light emitted from the one of the pixels connected to the first measurement circuit.

The first measurement circuit includes a first integrator circuit and the second measurement circuit includes a second integrator circuit. The first integrator circuit includes a first operation amplifier including a non-inverting input terminal receiving a reference voltage and an inverting input terminal connected to one of the first, second, and third pixels in the first pixel group, a first feedback capacitor connected between the inverting input terminal of the first operation amplifier and an output terminal of the first operation amplifier, and a first feedback switch connected in parallel to the first feedback capacitor. The second integrator circuit includes a second operation amplifier including a non-inverting input terminal receiving the reference voltage and an inverting input terminal connected to one of the first, second, and third pixels in the second pixel group, a second feedback capacitor connected between the inverting input terminal of the second operation amplifier and an output terminal of the second operation amplifier and a second feedback switch connected in parallel to the second feedback capacitor.

A level of the reference voltage may be equal to or higher than that of a threshold voltage of an organic light-emitting diode in each of the first, second, and third pixels.

Each of the current measurement channels may further include a first correlated double sampler (CDS) connected to the output terminal of the first operation amplifier, a first amplifier connected to the first CDS, a second CDS connected to the output terminal of the second operation amplifier and a second amplifier connected to the second CDS.

Each of the current measurement channels may further include a comparator which compares output signals of the first and second measurement circuits and an analog-to-digital converter (ADC) which converts an output signal of the comparator into a digital value.

The organic light-emitting display may further include a multiplexer connected between the display panel and the current measurement unit.

The organic light-emitting display may further include a timing controller including a latch circuit unit connected to the current measurement channels, a memory unit connected to the latch circuit unit, and an operation unit receiving an output signal of the latch circuit unit and generating a compensation value.

The organic light-emitting display may further include a data driver including a plurality of digital-to-analog converters (DACs) connected to the data lines and a plurality of first switches connected between the display panel and the DACs.

The first pixel includes a first organic light-emitting diode which emits light of a first color, the second pixel includes a second organic light-emitting diode which emits light of a second color, and the third pixel includes a third organic light-emitting diode which emits light of a third color, wherein the first, second, and third colors are different from one another.

In other embodiments of the present invention, an organic light-emitting display including a display panel having first and second pixel groups, each group including first, second, and third pixels which emit light of different colors and a current measurement channel having a first measurement circuit which applies a reference voltage to one of the first, second, and third pixels in the first pixel group during a reference voltage applying period and a second measurement circuit which applies the reference voltage to a pixel, among the first, second, and third pixels in the second pixel group, which emits light of a same color as that of light emitted from the pixel receiving the reference voltage from the first measurement circuit, during the reference voltage applying period, wherein the current measurement channel measures current characteristics of an organic light-emitting diode in a pixel connected to the first measurement circuit and measures current characteristics of an organic light-emitting diode in a pixel connected to the second measurement circuit during a measurement period following the reference voltage applying period.

A level of the reference voltage may be equal to or higher than that of a threshold voltage of an organic light-emitting diode in a pixel receiving the reference voltage among the first, second, and third pixels.

The first measurement circuit may include a first integrator circuit which measures current characteristics of an organic light-emitting diode in a pixel receiving the reference voltage from the first measurement circuit, during the measurement period, a first amplifier which amplifies an output signal of the first integrator circuit and a first CDS which removes noise from an output signal of the first amplifier, and the second measurement circuit includes a second integrator circuit which measures current characteristics of an organic light-emitting diode in a pixel receiving the reference voltage from the second measurement circuit, during the measurement period, a second amplifier which amplifies an output signal of the second integrator circuit and a second CDS which removes noise from an output signal of the second amplifier.

The current measurement channel may further include a comparator which compares output signals of the first and second measurement circuits and an ADC which converts an output signal of the comparator into a digital value.

The organic light-emitting display may further include a current measurement unit including a plurality of current measuring channels including the current measurement channel and a multiplexer which provides signal paths between the current measurement channels and the display panel, second, and a switching operation.

The organic light-emitting display may further include a timing controller including a memory unit storing output signals of the current measurement channels and an operation unit generating a compensation value using the output signals of the current measurement channels.

The organic light-emitting display may further include a data driver having a plurality of DACs which provide data signals to the display panel, second, and data lines and a plurality of first switches which selectively connect or disconnect signal paths between the display panel and the DACs, second, and switching operations.

According to an embodiments of the present invention, a method of driving an organic light-emitting display including first and second pixel groups, each having first, second, and third pixels which emit light of different colors, the method includes applying a reference voltage to one of the first, second, and third pixels in the first pixel group and to one of the first, second, and third pixels in the second pixel group in a reference voltage applying period and measuring current characteristics of an organic light-emitting diode in each pixel receiving the reference voltage among the pixels in the first and second pixel groups in a measurement period following the reference voltage applying period, wherein the pixel receiving the reference voltage among the first, second, and third pixels in the first pixel group and the pixel receiving the reference voltage among the first, second, and third pixels in the second pixel group have the same color.

A level of the reference voltage may be equal to or higher than that of a threshold voltage of the organic light-emitting diode in each pixel receiving the reference voltage.

The organic light-emitting display may further include a current measurement channel having a first measurement circuit which applies the reference voltage to one of the first, second, and third pixels in the first pixel group in the reference voltage applying period and measures current characteristics of an organic light-emitting diode in the pixel receiving the reference voltage in the measurement period and a second measurement circuit which applies the reference voltage to a pixel, which emits light of the same color as that of light emitted from the pixel receiving the reference voltage from the first measurement circuit, among the first, second, and third pixels in the second pixel group in the reference voltage applying period and measures current characteristics of an organic light-emitting diode in the pixel receiving the reference voltage from the second measurement circuit in the measurement period.

The method may further include performing correlated double sampling on output signals of the first and second measurement circuits, amplifying the two output signals, which underwent the correlated double sampling, calculating a difference voltage by comparing the two amplified signals and converting the difference voltage into a digital signal.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of an organic light-emitting display according to an embodiment of the present invention;

FIG. 2 is a circuit diagram of a first pixel group included in a display panel of the organic light-emitting display of FIG. 1;

FIG. 3 is a block diagram of an area a of the organic light-emitting display of FIG. 1;

FIG. 4 is a diagram illustrating, in more detail, a current measurement channel included in the area a of FIG. 3;

FIG. 5 is a diagram illustrating, in more detail, a timing controller included in the organic light-emitting display of FIG. 1;

FIG. 6 is a timing diagram illustrating a method of driving the organic light-emitting display of FIG. 1;

FIG. 7 is a circuit diagram illustrating the operating state of the organic light-emitting display according to an embodiment of the present invention in a reference voltage applying period;

FIG. 8 is a circuit diagram illustrating the operating state of the organic light-emitting display according to the present invention in a measurement period; and

FIG. 9 is a flowchart illustrating a method of driving an organic light-emitting display according to an embodiment of the present invention.

### DETAILED DESCRIPTION

Features of embodiments of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims and their equivalents. Like reference numerals refer to like elements throughout the specification.

The terminology used herein is for the purpose of describing particular embodiments only and is not intended to be limiting of the invention. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer or intervening elements or layers may be present. When an element is referred to as being “directly on”, “directly connected to,” “directly coupled to,” “directly connected with,” “directly coupled with,” or “immediately adjacent to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer, or section from another element, component, region, layer, or section. Thus, a first element, component, region, layer or section discussed below could be termed a second element, component, region, layer or section without departing from the spirit and scope of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Further, it will also be understood that when one element, component, region, layer and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections may also be present.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same or substantially the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

The organic light-emitting display and/or any other relevant devices or components according to embodiments of the present invention described herein may be implemented utilizing any suitable hardware, firmware (e.g. an application-specific integrated circuit), software, or a suitable combination of software, firmware, and hardware. For example, the various components of the organic light-emitting display may be formed on one integrated circuit (IC) chip or on separate IC chips. Further, the various components of the organic light-emitting display may be implemented on a flexible printed circuit film, a tape carrier package (TCP), a printed circuit board (PCB), or formed on a same substrate as the organic light-emitting display. Further, the various components of the organic light-emitting display may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

Hereinafter, embodiments of the present invention will be described with reference to the accompanying drawings.

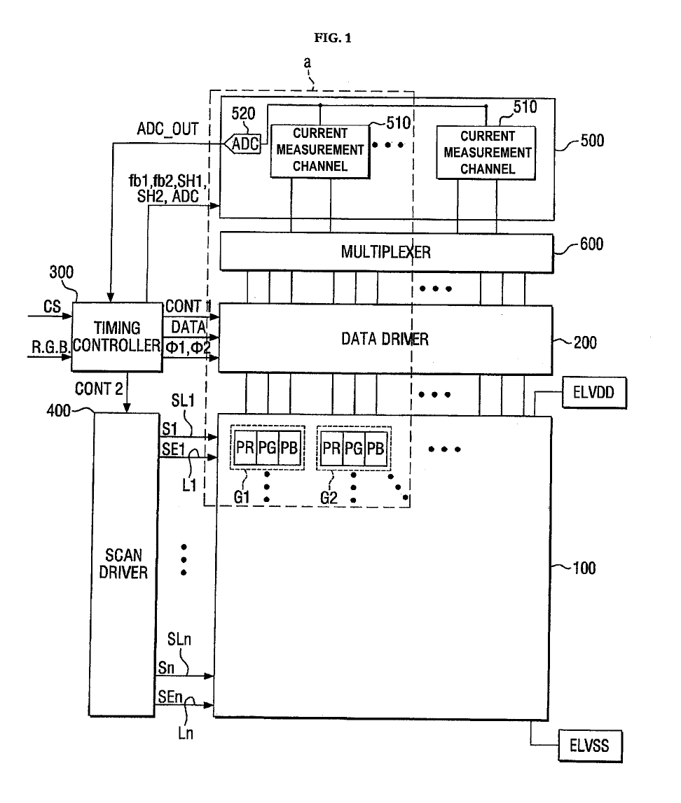

FIG. 1 is a block diagram of an organic light-emitting display according to an embodiment of the present invention.

Referring to FIG. 1, the organic light-emitting display according to the current embodiment may include a display panel 100, a data driver 200, a timing controller 300, a scan driver 400, and a power providing unit (e.g., a power supply).

The display panel 100 may be an area in which an image is displayed. The display panel 100 may include a plurality of data lines DL1 through DLm (where m is a natural number greater than one), a plurality of scan lines SL1 through SLn (where n is a natural number greater than one) crossing the data lines DL1 through DLm, and a plurality of sensing lines L1 through Ln (where n is a natural number greater than one) crossing the data lines DL1 through DLm. In addition, the display panel 100 may include a plurality of pixels disposed at intersections of the data lines DL1 through DLm and the scan lines SL1 through SLn. The data lines DL1 through DLm, the scan lines SL1 through SLn, the sensing lines L1 through Ln, and the pixels may be disposed on one substrate. The data lines DL1 through DLm, the scan lines SL1 through SLn, and the sensing lines L1 through Ln may be insulated from one another. The data lines DL1 through DLm may extend along a first direction d1, and the scan lines S1 through Sn and the sensing lines L1 through Ln may extend along a second direction d2 crossing the first direction d1. In FIG. 1, the first direction d1 may be a column direction, and the second direction d2 may be a row direction.

The pixels may be arranged in a matrix. Each of the pixels may be connected to one of the data lines DL1 through DLm, one of the scan lines SL1 through SLn, and one of the sensing lines L1 through Ln. Each of the pixels may receive a scan signal (one of S1 through Sn) through a connected scan line (one of SL1 through SLn) and receive a data signal (one of D1 through Dm) through a data line (one of DL1 through DLm). The pixels may include first and second pixel groups G1 and G2, each having first, second, and third pixels PR, PG, and PB which emit light of different colors. The first pixel PR may include a first organic light-emitting diode which emits light of a first color, and the second pixel PG may include a second organic light-emitting diode which emits light of a second color. In addition, the third pixel PB may include a third organic light-emitting diode which emits light of a third color. Here, the first color may be red, and the second color may be green. In addition, the third color may be blue. That is, each of the first and second pixel groups G1 and G2 may include the first, second, and third pixels PR, PG, and PB which emit light of the first, second, and third colors, respectively. Each of the pixels may be connected to a first power supply terminal ELVDD by a first power supply line and may be connected to a second power supply terminal ELVSS by a second power supply line. Each of the pixels may control the amount of current flowing from the first power supply terminal ELVDD to the second power supply terminal ELVSS according to a data signal (one of D1 through Dm) received from a data line (one of DL1 through DLm).

The data driver 200 may be connected to the display panel 100 by the data lines DL1 through DLm. The data driver 200 may provide a plurality of data signals D1 through Dm through the data lines DL1 through DLm under the control of the timing controller 300. The data driver 200 may provide a data signal (one of D1 through Dm) to a pixel selected according to a scan signal (one of S1 through Sn). Each pixel of the display panel 110 may be turned on by a scan signal (one of S1 through Sn) at a low level and may display an image by emitting light according to a data signal (one of D1 through Dm) received from the data driver 200.

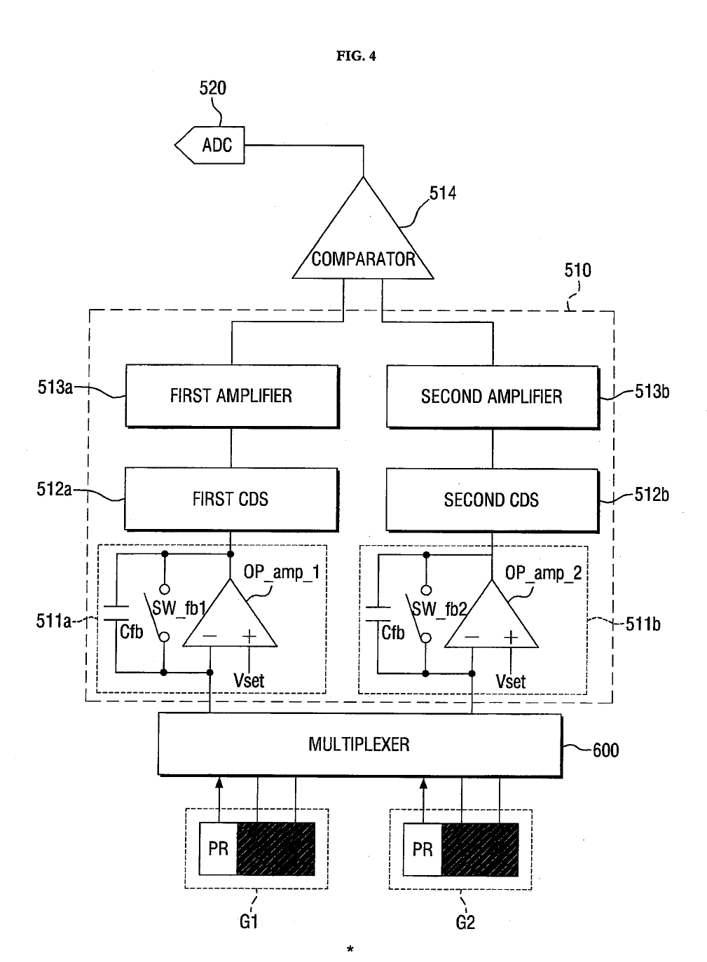

The timing controller 300 may receive a control signal CS and an image signal R, G, B from an external system. The control signal CS may include a vertical synchronization signal Vsync and a horizontal synchronization signal Hsync. The image signal R, G, B includes luminance information of the pixels. Luminance may have 1024, 256, or 64 gray levels. The timing controller 300 may generate image data DATA by dividing the image signal R, G, B on a frame-by-frame basis according to the vertical synchronization signal Vsync and dividing the image signal R, G, B on a scan line-by-scan line basis according to the horizontal synchronization signal Hsync. The timing controller 300 may provide control signals CONT1 and CONT2 respectively to the data driver 200 and the scan driver 400 in response to the control signal CS and the image signal R, G, B. The timing controller 300 may provide the image data DATA to the data driver 200 together with the control signal CONT1, and the data driver 200 may generate the data signals D1 through Dm by sampling and holding the input image data DATA and converting the image data DATA into analog voltages according to the control signal CONT1. The data driver 200 may transmit the data signals D1 through Dm to the pixels through the data lines DL1 through DLm. The timing controller 300 may provide a current measurement unit 500 with first and second feedback control signals fb1 and fb2 for controlling switching operations of first and second feedback switches SW_fb1 and SW_fb2 (see FIG. 4), first and second sampling control signals SH1 and SH2 for controlling the operations of first and second correlated double samplers (CDSes) 512a and 512b (see FIG. 4), and a control signal ADC for controlling the operation of an analog-to-digital converter (ADC) 520. In addition, the timing controller 300 may provide the data driver 200 with first and second control signals (Φ1 and Φ2 for controlling switching operations of first and second switches SW_1 and SW_2.

The scan driver 140 may be connected to the display panel 100 by the scan lines SL1 through SLn and the sensing lines L1 through Ln. The scan driver 400 may sequentially transmit a plurality of scan signals S1 through Sn to the scan lines SL1 through SLn according to the control signal CONT2 received from the timing controller 300. In addition, the scan driver 400 may provide sensing signals SE1 through SEn to pixels, whose electric currents are to be measured during a sensing period, through the sensing lines L1 through Ln. In the present specification, a case where the scan driver 400 provides the sensing signals SE1 through SEn to the pixels is described as an example. However, the present invention is not limited to this case, and the sensing signals SE1 through SEn can also be provided to the pixels through a separate integrated circuit (IC) and the sensing lines L1 through Ln connected to the IC. To this end, the scan driver 400 may include a scan signal providing unit (e.g., a scan signal provider) which is connected to the scan lines SL1 through SLn and a sensing signal providing unit (e.g., a sensing signal provider) which is connected to the sensing lines L1 and Ln. The timing controller 300 may control a switching operation according to the control signal CONT2, and one of the scan signal providing unit and the sensing signal providing unit may be selected by the switching operation.

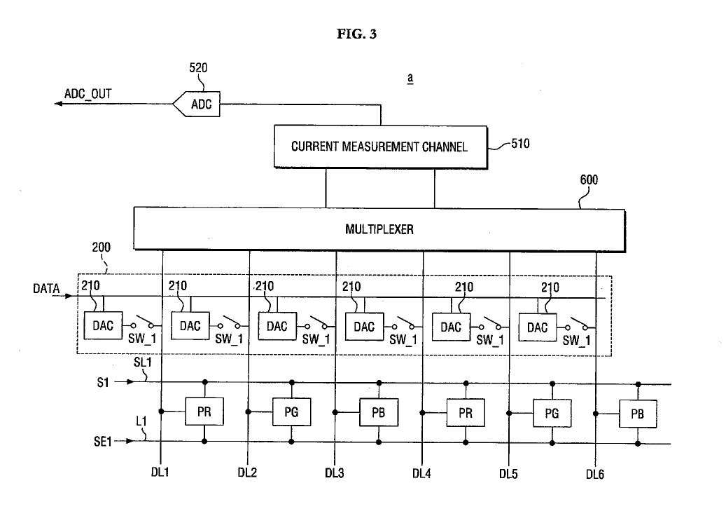

The current measurement unit 500 may be connected to the display panel 100 by the data lines DL1 through DLm. The current measurement unit 500 may include a plurality of current measurement channels 510, each connected to two of the data lines DL1 through DLm connected to the display panel 100. To this end, the organic light-emitting display according to the current embodiment may further include a multiplexer 600. The multiplexer 600 may be connected between the data driver 200 and the current measurement unit 500 and may connect the data lines DL1 through DLm and the current measurement unit 500 through a switching operation. The current measurement unit 500 may include the current measurement channels 510 and the ADC 520. Each of the current measurement channels 510 may be connected two pixels of the display panel 100 by the switching operation of the multiplexer 600. Here, the two pixels connected to each of the current measurement channels 510 may respectively include organic light-emitting diodes which emit light of the same or substantially the same color. Referring to an area a of FIG. 1, each of the current measurement units 510 may be connected to two data lines by the switching operation of the multiplexer 600. One of the two data lines may be connected to one of the first, second, and third pixels PR, PG, and PB, and the other one of the data lines may be connected to one of the first, second, and third pixels PR, PG, and PB. Here, the pixels connected to the two data lines may respectively include organic light-emitting diodes which emit light of the same or substantially the same color. For example, one of two data lines connected to a current measurement channel 510 may be connected to the first pixel PR in each first pixel group G1, and the other one of the data lines may be connected to the first pixel PR in each second pixel group G2. This will be described later with reference to FIGS. 3 and 4. The ADC 520 may receive output signals of the current measurement channels 510, convert the output signals into digital signals ADC_OUT, and provide the digital signals ADC_OUT to the timing controller 300. The current measurement unit 500 may further include a multiplexer disposed between the ADC 520 and the current measurement channels 510. The multiplexer may provide the output signals of the current measurement channels 510 to the ADC 520 through a switching operation. For the switching operation of the multiplexer, the current measurement unit 500 according to embodiments of the present invention may further include a shift register. The multiplexer may provide the output signals of the current measurement channels 510 to the ADC 520 under the control of the shift register. The ADC 520 may convert the output signals of the current measurement channels 520 into the digital signals ADC_OUT and provide the digital signals ADC_OUT to the timing controller 300. The ADC 520 may be implemented as a pipelined ADC, a successive approximation register (SAR) ADC, or a single-slope type ADC.

The power providing unit may provide driving voltages to the pixels according to a control signal received from the timing controller 300. A voltage provided by the first power supply terminal ELVDD may be at a high level, and a voltage provided by the second power supply terminal ELVSS may be at a low level. The first and second power supply terminals ELVDD and ELVSS may provide driving voltages for the operation of the pixels. The voltage provided by the first power supply terminal ELVDD will hereinafter be indicated by reference character ELVDD, and the voltage provided by the second power supply terminal ELVSS will be indicated by reference character ELVSS. The power providing unit may provide a reference voltage Vset to the data driver 200. The reference voltage Vset provided by the power providing unit may be applied to each of non-inverting input terminals (+) of first and second operation amplifiers OP_amp_1 and OP_amp_2 (see FIG. 4).

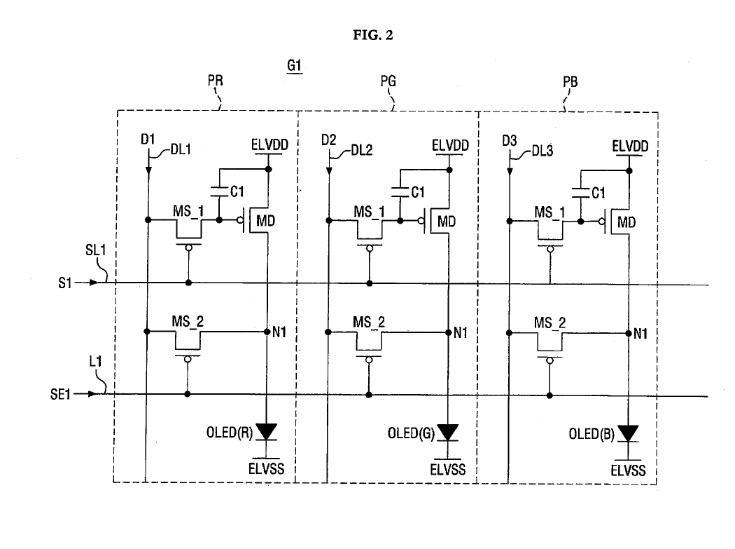

FIG. 2 is a circuit diagram of a first pixel group G1 included in the display panel 100 of the organic light-emitting display of FIG. 1. Since each of the first and second pixel groups G1 and G2 includes the first, second, and third pixels PR, PB and PG, the following description will be focused on the first pixel group G1. The first and second pixel groups G1 and G2 illustrated in FIGS. 1 and 2 have been arbitrarily defined to describe the first, second, and third pixels PR, PG, and PB, and positions of the first, second, and third pixels PR, PG, and PB in the display panel 100 are not limited to the example illustrated in FIG. 1. As long as each of the first and second pixel groups G1 and G2 includes at least one of each of the first, second, and third pixels PR, PG, and PB, the number of pixels or the arrangement of the pixels is not limited to the example illustrated in FIG. 2. Hereinafter, a first pixel group G1 connected to the first through third data lines DL1 through DL3, the first scan line SL1, and the first sensing line L1 will be described.

Referring to FIG. 2, the first pixel group G1 may include a first pixel PR which is connected to the first data line DL1 and has a first organic light-emitting diode OLED(R), a second pixel PG which is connected to the second data line DL2 and has a second organic light-emitting diode OLED(G), and a third pixel PB which is connected to the third data line DL3 and has a third organic light-emitting diode OLED(B).

The first pixel PR may include a switch transistor MS_1, a driving transistor MD, a sensing transistor MS_2, a first capacitor C1, and the first organic light-emitting diode OLED(R). The switch transistor MS_1 may include a gate electrode connected to the first scan line SL1 to receive the first scan signal S1, a first electrode connected to the first data line DL1 to receive the data signal D1, and a second electrode connected to a first terminal of the first capacitor C1. The switch transistor MS_1 may be turned on by the first scan signal S1 transmitted to the gate electrode through the first scan line SL1 and deliver the first data signal D1 received through the first data line DL1 to the first capacitor C1. The driving transistor MD may include a first electrode connected to the first power supply terminal ELVDD, a second electrode connected to a first node N1, and a gate electrode connected to the second electrode of the switch transistor MS_1. The driving transistor MD may control a driving current supplied to the second power supply terminal ELVSS from the first power supply terminal ELVDD via the first organic light-emitting diode OLED(R) according to a voltage corresponding to the first data signal D1 transmitted to the gate electrode. The sensing transistor MS_2 may include a first electrode connected to the first data line DL1, a second electrode connected to the first node N1, and a gate electrode connected to the sensing line L1. The sensing transistor MS_2 may be turned on by the first sensing signal SE1 received through the first sensing line L1. The sensing transistor MS_2 may measure information about driving characteristics (e.g., a driving current) of the driving transistor MD. In a sensing period, the sensing transistor MS_2 may measure an electric current flowing through the first organic light-emitting diode OLED(R) such that the measured electric current can be read out through the first sensing line L1. The first organic light-emitting diode OLED(R) may include an anode connected to the first node N1, a cathode connected to the second power supply terminal ELVSS, and an organic light-emitting layer. The organic light-emitting layer included in the first organic light-emitting diode OLED(R) may emit light of a first color which is one of primary colors. The primary colors may be red, green, and blue, and the first color may be, for example, red. The spatial or temporal sum of the three primary colors may produce a desired color. The organic light-emitting layer included in the first organic light-emitting diode OLED(R) may include low molecular weight organic matter or polymer organic matter corresponding to the first color. The organic matter corresponding to each color may emit light according to the amount of electric current flowing through the organic light-emitting layer. The first capacitor C1 may include the first terminal connected to the second electrode of the switch transistor MS_1 and a second terminal connected to the first electrode of the driving transistor MD. The first data signal D1 provided through the first data line DL1 may be transmitted to the first capacitor C1 by a switching operation of the switch transistor MS_1. The switch transistor MS_1, the driving transistor MD and the sensing transistor MS_2 may be, for example, p-type transistors.

Unlike the first pixel PR, the second pixel PG may include the second organic light-emitting diode OLED(G). Therefore, the second pixel PG may include an organic light-emitting layer having low molecular weight organic matter or polymer organic matter corresponding to a second color. Here, the second color may be, for example, green. In addition, a switch transistor MS_1 may have a first electrode connected to the second data line DL2 so as to receive the second data signal D2. Other elements of the second pixel PG are identical to those of the first pixel PR, and thus a redundant description thereof will be omitted.

Unlike the first and second pixels PR and PG, the third pixel PB may include the third organic light-emitting diode OLED(B). Therefore, the third organic light-emitting diode OLED(B) may include an organic light-emitting layer having low molecular weight organic matter or polymer organic matter corresponding to a third color. Here, the third color may be, for example, blue. In addition, a switch transistor MS_1 may have a first electrode connected to the third data line DL3 to receive the third data signal D3. Other elements of the third pixel PB are identical to those of the first pixel PR, and thus a redundant description thereof will be omitted.

FIG. 3 is a block diagram of the area a of the organic light-emitting display of FIG. 1.

Referring to FIG. 3, the data driver 200 may be connected to each of the data lines DL1 through DLm. The data driver 200 may convert the image data DATA received from the timing controller 300 into the data signals D1 through Dm in an analog form and provide the data signals D1 through Dm respectively to the data lines DL1 through DLm. To this end, the data driver 200 may include a plurality of digital-to-analog converters (DACs) 210 and a plurality of first switches SW_1 connected between the DACs 210 and the data lines DL1 through DLm, respectively. The first switches SW_1 may be, for example, n-type switches. The DACs 210 may convert the image data DATA in a digital form received from the timing controller 300 into the data signals D1 through Dm in an analog form. The first switches SW_1 may perform switching operations in response to the first control signal Φ1 received from the timing controller 300. The first switches SW_1 may be turned on by the first control signal Φ1 in a display period, thereby connecting signal paths between the DACs 210 and the data lines DL1 through DLm connected one-to-one to the DACs 210. The multiplexer 600 may be connected between the current measurement channels 510 and the data driver 200 and may include a plurality of switches. The multiplexer 600 may connect or block or disconnect signal paths between pixels in the first and second pixel groups G1 and G2 and the current measurement channels 510 through switching operations of the switches. For the switching operation of the multiplexer 600, the organic light-emitting display according to embodiments of the present invention may further include a shift register. The multiplexer 600 may connect or block or disconnect signal paths between the current measurement channels 510 and pixels which emit light of the same or substantially the same color in the first and second pixel groups G1 and G2 under the control of the shift register.

FIG. 4 is a diagram illustrating, in more detail, the current measurement channel 510 included in the area a of FIG. 3. Referring to FIG. 4, the current measurement channel 510 may include a first measurement circuit 511a, a second measurement circuit 511b, the first CDS 512a, the second CDS 512b, a first amplifier 513a, a second amplifier 513b, and a comparator 514. A case where the first measurement circuit 511a is connected to the first pixel PR in a first pixel group G1 by a switching operation of the multiplexer 600 and where the second measurement circuit 511b is connected to the second pixel PR in a second pixel group G2 by the switching operation of the multiplexer 600 will now be described as an example.

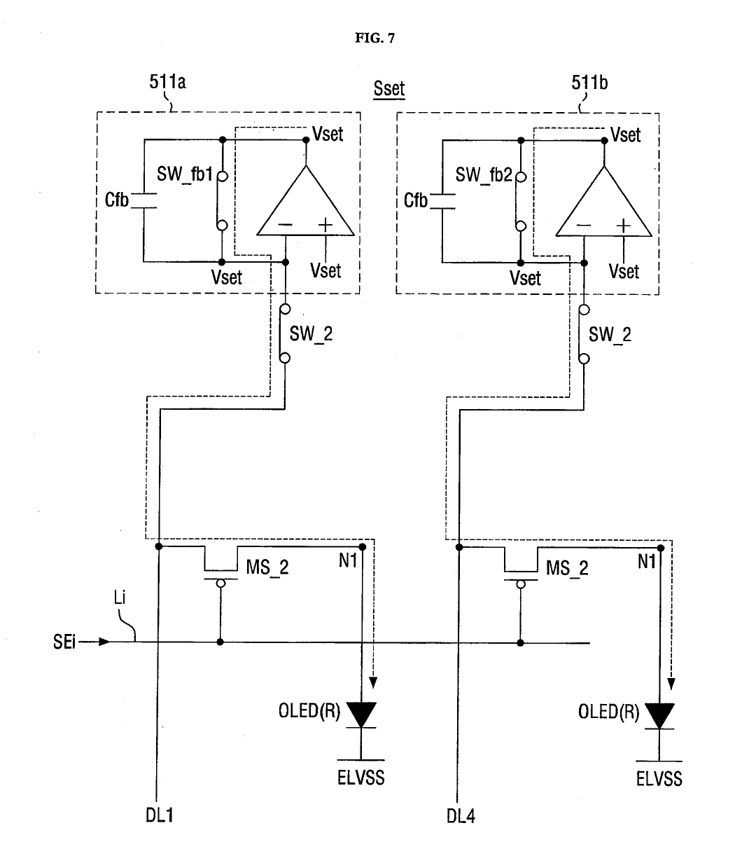

The first measurement circuit 511a may include a first operation amplifier OP_amp_1, a feedback capacitor Cfb, and a first feedback switch SW_fb1. The first feedback switch SW_fb1 may be, for example, an n-type switch. The first operation amplifier OP_amp_1 may include an inverting input terminal (−), a non-inverting input terminal (+), and an output terminal. A reference voltage Vset from the power providing unit may be applied to the non-inverting input terminal (+) of the first operation amplifier OP_amp_1. To allow the first measurement circuit 511a to read out signal and noise, the reference voltage Vset may be a voltage corresponding to (signal+noise) and may be at a level equal to or substantially equal to or higher than a threshold voltage Vth of the first organic light-emitting diode OLED(R) in the first pixel PX1. The first pixel PR in the first pixel group G1 may be electrically connected to the inverting input terminal (−) of the first operation amplifier OP_amp_1. Although not illustrated in the drawing, the organic light-emitting display according to embodiments of the present invention may further include a second switch SW_2 (see FIG. 7) connected between the inverting input terminal (−) of the first operation amplifier OP_amp_1 and the multiplexer 600. The second switch SW_2 (see FIG. 7) may perform a switching operation in response to the second control signal Φ2 from the timing controller 300, thereby connecting or blocking or disconnecting a signal path between the inverting input terminal (−) of the first operation amplifier OP_amp_1 and the multiplexer 600. That is, in a measurement period, the first switch SW_1 connected between the data driver 200 and the first data line DL1 is turned off, whereas the second switch SW_2 is turned on. Accordingly, the inverting input terminal (−) of the first operation amplifier OP_amp_1 may be connected to the first pixel PR in the first pixel group G1 by the first data line DL1. The feedback capacitor Cfb may have a first terminal connected to the inverting input terminal (−) of the first operation amplifier OP_amp_1 and a second terminal connected to the output terminal of the first operation amplifier OP_amp_1. The first feedback switch SW_fb1 may be connected in parallel to the feedback capacitor Cfb between the inverting input terminal (−) of the first operation amplifier OP_amp_1 and the output terminal of the first operation amplifier OP_amp_1. The first feedback switch SW_fb1 may perform a switching operation in response to the feedback control signal fb1 received from the timing controller 300.

The second measurement circuit 511b may include a second operation amplifier OP_amp_2, a feedback capacitor Cfb, and a second feedback switch SW_fb2. The second operation amplifier OP_amp_2 may include an inverting input terminal (−), a non-inverting input terminal (+), and an output terminal. A reference voltage Vset having the same or substantially the same level as the reference voltage Vset provided to the non-inverting input terminal (+) of the first operation amplifier OP_amp_1 may be applied from the power providing unit to the non-inverting input terminal (+) of the second operation amplifier OP_amp_2. The first pixel PR in the second pixel group G2 may be electrically connected to the inverting input terminal (−) of the second operation amplifier OP_amp_2. Although not illustrated in the drawing, the organic light-emitting display according to embodiments of the present invention may further include a second switch SW_2 (see FIG. 7) connected between the inverting input terminal (−) of the second operation amplifier OP_amp_2 and the multiplexer 600. The second switch SW_2 (see FIG. 7) may perform a switching operation in response to the second control signal Φ2 from the timing controller 300, thereby connecting or blocking or disconnecting a signal path between the inverting input terminal (−) of the second operation amplifier OP_amp_2 and the multiplexer 600. That is, in a measurement period, the first switch SW_1 connected between the data driver 200 and the first data line DL1 is turned off, whereas the second switch SW_2 is turned on. Accordingly, the inverting input terminal (−) of the second operation amplifier OP_amp_2 may be connected to the first pixel PR in the second pixel group G2 by the fourth data line DL4. In FIG. 4, the first pixels PR in the first and second pixel groups G1 and G2 are connected to the first and second measurement circuits 511a and 511b by the first and fourth data lines DL1 and DL4, respectively. However, the present invention is not limited thereto, and data lines that connect the first pixels PR in the first and second pixel groups G1 and G2 to the first and second measurement circuits 511a and 511b may vary according to the arrangement of the first and second pixel groups G1 and G2 in the display panel 100 or the switching operation of the multiplexer 600. Other elements of the second measurement circuit 511b which are identical to those of the first measurement circuit 511a will not be described again.

The first CDS 512a may be connected between an output terminal of the first measurement circuit 511a (i.e., the output terminal of the first operation amplifier OP_amp_1) and the first amplifier 513a. The first CDS 512a may perform correlated double sampling on an output signal of the first operation amplifier OP_amp_1 under the control of the timing controller 300. The first CDS 512a may receive a voltage signal corresponding to noise and compare the voltage signal with the output signal of the first operation amplifier OP_amp_1. The first CDS 512a may detect a potential difference between the voltage signal corresponding to the noise and the output signal of the first operation amplifier OP_amp_1. Accordingly, the voltage signal corresponding to the noise can be removed from the output signal of the first operation amplifier OP_amp_1 which has a voltage level corresponding to (signal+noise), and a good signal-to-noise ratio (SNR) can be maintained.

Likewise, the second CDS 512b may be connected between an output terminal of the second measurement circuit 511b (i.e., the output terminal of the second operation amplifier OP_amp_2) and the second amplifier 513b. The second CDS 512b may perform correlated double sampling on an output signal of the second operation amplifier OP_amp_2 under the control of the timing controller 300. Accordingly, a voltage signal corresponding to noise can be removed from the output signal of the second operation amplifier OP_amp_2, and a good SNR can be maintained.

The first amplifier 513a may amplify a signal received from the first CDS 512a (e.g., amplify to a preset size). The second amplifier 513b may amplify a signal received from the second CDS 512b (e.g., amplify to a preset size). The comparator 514 may receive respective output signals of the first and second amplifiers 513a and 513b, calculate a potential difference between the output signals, and output the potential difference to the ADC 520. In an embodiment, the comparator 514 may include an operation amplifier.

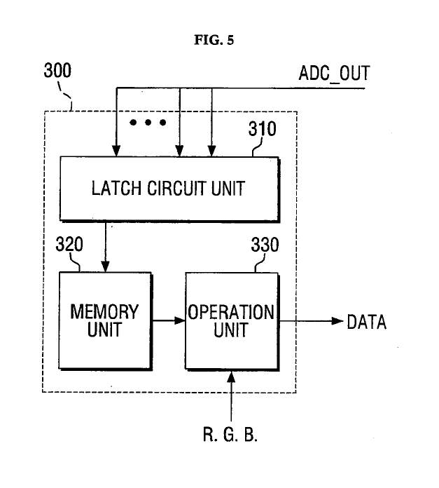

FIG. 5 is a diagram illustrating, in more detail, the timing controller 300 included in the organic light-emitting display of FIG. 1.

Referring to FIG. 5, the timing controller 300 may include a latch circuit unit 310, a memory unit 320, and an operation unit 330. The latch circuit unit 310 may be connected to the ADC 520 (see FIG. 4) of the current measurement unit 500.

The latch circuit unit 310 may temporarily store a digital signal received from the ADC 520 (see FIG. 4) and provide the digital signal to the memory unit 320. The memory unit 320 may store the digital signal in a digital space corresponding to each pixel. For example, the memory unit 320 may store the result of comparing current characteristics of the first pixel PR in a first group G1 (see FIG. 1) and current characteristics of the first pixel PR in a second pixel group G2 (see FIG. 1) in an arbitrary digital space YR1. In addition, the memory unit 320 may store the result of comparing the current characteristics of the first pixel PR in the second group G2 (see FIG. 1) and current characteristics of the first pixel PR in a third pixel group G3 (see FIG. 1) in an arbitrary digital space YR2. That is, the memory unit 320 may store the result of comparing current characteristics of an n^{th} group Gn (where n is a natural number of 1 or greater) and an (n+1)^{th} group Gn+1 in an arbitrary digital space YR(N) (where N is a natural number of 1 or greater). Accordingly, the degrees of degradation of a plurality of pixels in one row can all be compared. The operation unit 330 may calculate a compensation value using a digital value stored in the memory 320. The operation unit 330 may generate the image data DATA by compensating the image signal R, G, B received from an external source using the calculated compensation value. The timing controller 300 may provide the generated image data DATA to the data driver 200.

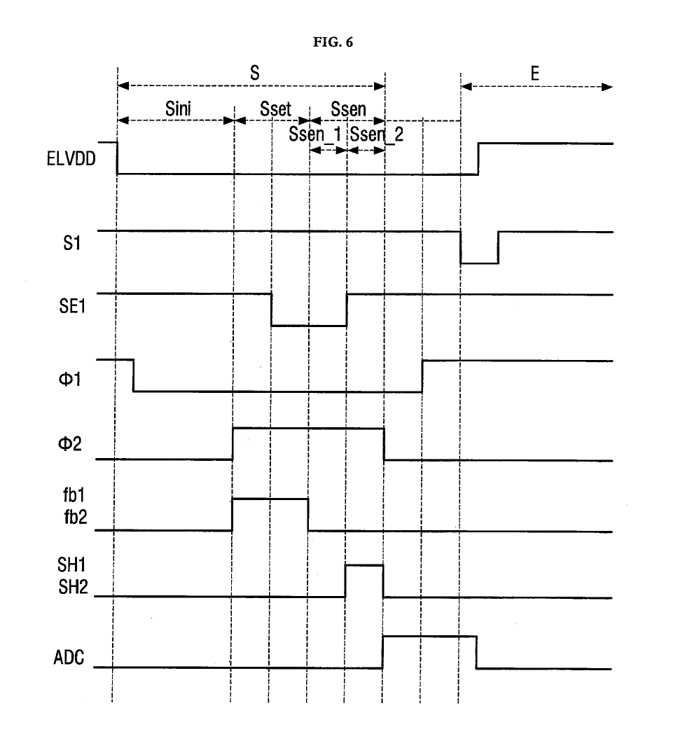

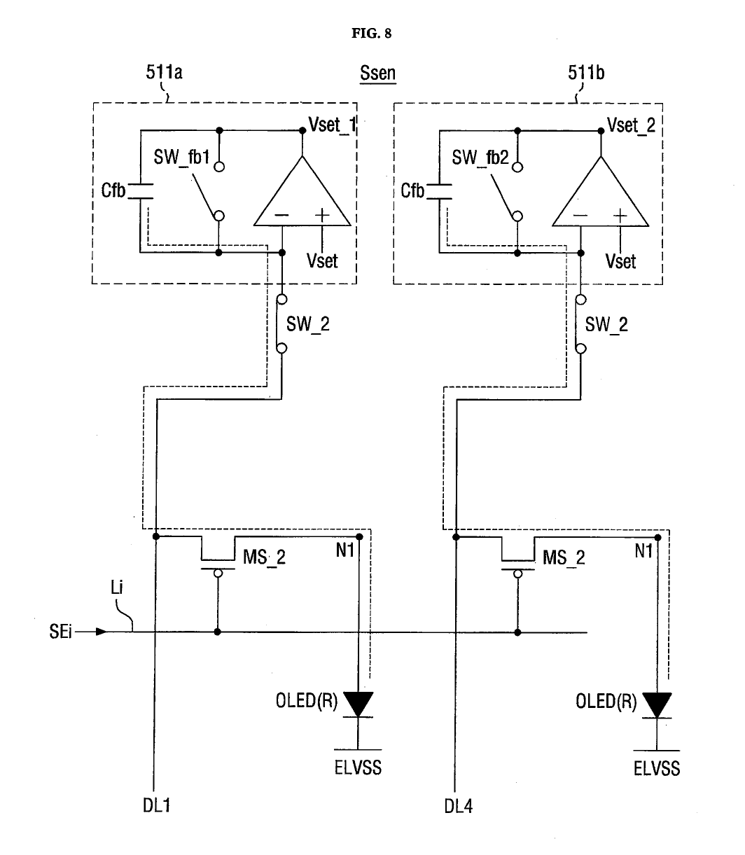

FIG. 6 is a timing diagram illustrating a method of driving the organic light-emitting display of FIG. 1. FIG. 7 is a circuit diagram illustrating the operating state of the organic light-emitting display according to embodiments of the present invention in a reference voltage applying period Sset. FIG. 8 is a circuit diagram illustrating the operating state of the organic light-emitting display according to embodiments of the present invention in a measurement period Ssen. In FIGS. 6 through 8, the area a of FIG. 1 will be described. That is, the relationship between a current measurement channel 510 and first and second pixel groups G1 and G2 located between the first through sixth data lines DL1 through DL6, the first scan line SL1 and the first sensing line L1 will be described as an example. In addition, current characteristics of the first pixel PR included in each of the first and second pixel groups G1 and G2 will be measured. Here, the first pixel PR may include the first organic light-emitting diode OLED(R) which emits light of the first color (e.g., red).

Referring to FIG. 6, the organic light-emitting display according to embodiments of the present invention may operate largely in two periods: a sensing period S and a display period E. The sensing period S is a period of time during which electric currents flowing through a plurality of organic light-emitting diodes OLEDs are measured to calculate current characteristics of the organic light-emitting diodes OLEDs which emit light of the same or substantially the same color. The sensing period S may be activated when the power of the organic light-emitting display is turned off or turned on. That is, the sensing period S may be activated during a standby time in which the power is turned on or off. However, the present invention is not limited thereto, and the sensing period S can also be activated at regular intervals or by a user's setting. The sensing period S may be divided into an initialization period Sini, the reference voltage applying period Sset, and the measurement period Ssen. In the initialization period Sini of the organic light-emitting display according to the current embodiment, the voltage level of the first power supply terminal ELVDD may be lowered to the voltage level of the second power supply terminal ELVSS, and all data lines DL1 through DLm may be charged with an initialization voltage. The reference voltage applying period Sset is a period of time during which the reference voltage Vset is applied to the anode of the organic light-emitting diode OLED(R), included in the first pixel PR of the first pixel group G1, and to the anode of the organic light-emitting diode OLED(R), included in the first pixel PR of the second pixel group G2. The measurement period Ssen is a period of time during which an electric current flowing through the organic light-emitting diode OLED(R), included in the first pixel PR of each of the first and second pixel groups G1 and G2, is measured as the reference voltage Vset is applied to the organic light-emitting diode OLED(R).

The operation of the organic light-emitting display in the initialization period Sini will now be described with reference to FIG. 6. The voltage level of the first power supply terminal ELVDD may be lowered to the voltage level of the second power supply terminal ELVSS. To this end, each of the first, second, and third pixels PR, PG, and PB included in the first and second pixel groups G1 and G2 may further include a power switch. The power switch may be connected between a power supply line connected to the driving transistor MD of each pixel and the first and second power supply terminals ELVDD and ELVSS to perform a switching operation under the control of the timing controller 300. That is, in the sensing period S, the power switch may connect a signal path between the first electrode of the driving transistor MD and the second power supply terminal ELVSS through its switching operation, thereby lowering an electric potential of the first power supply terminal ELVDD to an electric potential of the second power supply terminal ELVSS. In the present specification, a case where the voltage level of the first power supply terminal ELVDD is lowered to the voltage level of the second power supply terminal ELVSS by the switching operation of the power switch is described as an example. However, the present invention is not limited to this case. That is, the electric potential of the second power supply terminal ELVSS can also be increased to the electric potential of the first power supply terminal ELVDD. After the first control signal Φ1 at a low level may be generated, thereby turning off the first switches SW_1 in the data driver 200. Accordingly, this can prevent the provision of the first through sixth data signals D1 through D6 through the first through sixth data lines DL1 through DL6. Although not illustrated in the drawings, the organic light-emitting display according to embodiments of the present invention may further include an initialization switch connected between the power providing unit and the data lines DL1 through DLm. As the initialization switch is turned on in the initialization period Sini, all data lines DL1 through DLm charged with an arbitrary voltage due to coupling may be charged with the initialization voltage. Here, the level of the initialization voltage may be lower than that of the threshold voltage Vth of each of the first, second, and third organic light-emitting diodes OLED(R), OLED(G), and OLED(B) included in the first, second, and third pixels PR, PG, and PB.

The operation of the organic light-emitting display in the reference voltage applying period Sset of the sensing period S will now be described with reference to FIGS. 6 and 7. The first pixel PR included in the first pixel group G1 may be connected to the inverting input terminal (−) of the first operation amplifier OP_amp_1 by the first data line DL1, and the first pixel PR included in the second pixel group G2 may be connected to the inverting input terminal (−) of the second operation amplifier OP_amp_2 by the fourth data line DL4.

In the reference voltage applying period Sset, the second control signal Φ2 may be inverted to a high level to turn on the second switch SW_2. The first and second feedback control signals fb1 and fb2 may be inverted to a high level to turn on the first and second feedback switches SW_fb1 and SW_fb2. The first sensing signal SE1 may maintain a high level to continuously turn off the sensing transistor MS_2 (e.g., maintain the sensing transistor MS_2 in the off state) in each first pixel PR. The first sensing signal SE1 may be inverted to a low level to turn on the sensing transistor MS_2 in each first pixel PR. The first scan signal S1 may maintain a high level to continuously turn off the switch transistor MS_1 (e.g., maintain the switch transistor MS_1 in the off state) in each first pixel PR. The first control signal Φ1 may maintain a low level to continuously turn off the first switches SW_1 (e.g., maintain the first switches SW_1 in the off state) (see FIG. 3).

First, a section of the reference voltage applying period Sset in which the sensing transistor MS_2 of each first pixel PR remains turned off will be described.

The first operation amplifier OP_amp_1 may receive the reference voltage Vset through the non-inverting input terminal (+). In addition, the inverting input terminal (−) of the first operation amplifier OP_amp_1 and the output terminal of the first operation amplifier OP_amp_1 may short-circuit with each other. The inverting input terminal (−) of the first operation amplifier OP_amp_1 may be connected to the first pixel PX1 in the first pixel group G1 by the first data line DL1. The feedback capacitor Cfb of the first measurement circuit 511a may be reset due to the short circuit between the inverting input terminal (−) of the first operation amplifier OP_amp_1 and the output terminal of the first operation amplifier OP_amp_1. An electric potential of the output terminal of the first operation amplifier OP_amp_1 may be maintained with the reference voltage Vset, and an electric potential of the inverting input terminal (−) of the first operation amplifier OP_amp_1 may also be maintained with the reference voltage Vset due to virtual grounding characteristics of the first operation amplifier OP_amp_1. This reference voltage Vset may charge the first data line DL1.

The second operation amplifier OP_amp_2 may receive the reference voltage Vset through the non-inverting input terminal (+). In addition, the inverting input terminal (−) of the second operation amplifier OP_amp_2 and the output terminal of the second operation amplifier OP_amp_2 may short-circuit with each other. The inverting input terminal (−) of the second operation amplifier OP_amp_2 may be connected to the first pixel PR in the second pixel group G2 by the fourth data line DL4. The feedback capacitor Cfb of the second measurement circuit 511b may be reset due to the short circuit between the inverting input terminal (−) of the second operation amplifier OP_amp_2 and the output terminal of the second operation amplifier OP_amp_2. An electric potential of the output terminal of the second operation amplifier OP_amp_2 may be maintained with the reference voltage Vset, and an electric potential of the inverting input terminal (−) of the second operation amplifier OP_amp_2 may be maintained with the reference voltage Vset due to virtual ground characteristics of the second operation amplifier OP_amp_2. The reference voltage Vset may charge the fourth data line DL4.

Next, a section of the reference voltage applying period Sset in which the sensing transistor MS_2 of each first pixel PR is turned on will be described.

The first sensing signal SE1 may be inverted to a low level to turn on the sensing transistor MS_2 in each first pixel PR. Other signals may be maintained constant. Therefore, a switch receiving each of the signals may remain in the current state. In the case of the first pixel PR in the first pixel group G1, as the sensing transistor MS_2 is turned on, the reference voltage Vset charged in the first data line DL1 may be applied to the anode of the first organic light-emitting diode OLED(R) in the first pixel PR. Here, since the reference voltage Vset has a voltage value equal to or substantially equal to or higher than the threshold voltage Vth of the first organic light-emitting diode OLED(R) included in the first pixel PX1, an electric current may flow through the first organic light-emitting diode OLED(R) in the first pixel PR. The first pixel PR in the second pixel group G2 is identical to the first pixel PR in the first pixel group G1, and thus a redundant description thereof will be omitted. The magnitude of the electric current flowing through the first organic light-emitting diode OLED(R) in each of the first and second pixel groups G1 and G2 may vary according to the degree of degradation of the first organic light-emitting diode OLED(R).

The operation of the organic light-emitting display in the measurement period Ssen of the sensing period S will now be described with reference to FIGS. 6 and 8. The measurement period Ssen may include a first measurement period Ssen_1 following the reference voltage applying period Sset and a second measurement period Ssen_2 following the first measurement period Ssen_1. FIG. 8 is a circuit diagram illustrating the operation of the organic light-emitting display in the first measurement period Ssen_1.

In the first measurement period Ssen_1, the first and second feedback control signals fb1 and fb2 may be inverted to a low level to turn off the first and second feedback switches SW_fb1 and SW_fb2. The first sensing signal SE1 may be maintained at a low level to continuously turn on the sensing transistor MS_2 (e.g., maintain the sensing transistor MS_2 in the on state). The first scan signal S1 may be maintained at a high level to continuously turn off the switch transistor MS_1 (e.g., maintain the switch transistor MS_1 in the off state) in each first pixel PR. The first control signal Φ1 may be maintained at a low level to continuously turn off the first switch SW_1 (e.g., maintain the first switch SW_1 in the off state). The second control signal Φ2 may maintain a high level to continuously turn on the second switch SW_2 (e.g., maintain the second switch SW_2 in the off state). In the case of the first pixel PX1 in the first pixel group G1, the short circuit between the inverting input terminal (−) of the first operation amplifier OP_amp_1 and the output terminal of the first operation amplifier OP_amp_1 may be removed. Accordingly, the first operation amplifier OP_amp_1 can operate as an integrator. The inverting input terminal (−) of the first operation amplifier OP_amp_1 may be continuously connected to the first organic light-emitting diode OLED(R) of the first pixel PR in the first pixel group G1 by the second switch SW_2. The feedback capacitor Cfb in the first measurement circuit 511a may be charged with a voltage corresponding to an electric current flowing through the first organic light-emitting diode OLED(R) and a voltage corresponding to a leakage current in the first pixel PR. The leakage current may be generated in the switch transistor MS_1, the driving transistor MD, the sensing transistor MS_2, etc. of the first pixel PR in the first pixel group G1. Accordingly, an electric potential (Vout_1) of the output terminal of the first operation amplifier OP_amp_1 may increase linearly from the reference voltage Vset according to the voltage corresponding to the electric current flowing through the first organic light-emitting diode OLED(R) and the voltage corresponding to the leakage current in the first pixel PR of the first pixel group G1. In the case of the first pixel PR in the second pixel group G2, the short circuit between the inverting input terminal (−) of the second operation amplifier OP_amp_2 and the output terminal of the second operation amplifier OP_amp_2 may be removed. Accordingly, the second operation amplifier OP_amp_2 can operate as an integrator. The inverting input terminal (−) of the second operation amplifier OP_amp_2 may be continuously connected to the first organic light-emitting diode OLED(R), included in the first pixel PR of the second pixel group G2, by the second switch SW_2. The feedback capacitor Cfb in the second measurement circuit 511b may be charged with a voltage corresponding to an electric current flowing through the first organic light-emitting diode OLED(R) and a voltage corresponding to a leakage current in the first pixel PR. The leakage current may be generated in the switch transistor MS_1, the driving transistor MD, the sensing transistor MS_2, etc. of the first pixel PR in the second pixel group G2. Accordingly, an electric potential (Vout_2) of the output terminal of the second operation amplifier OP_amp_2 may increase linearly from the reference voltage Vset according to the voltage corresponding to the electric current flowing through the first organic light-emitting diode OLED(R) and the voltage corresponding to the leakage current in the first pixel PR of the second pixel group G2.

Referring back to FIGS. 4 and 6, in the second measurement period Ssen_2 following the first measurement period Ssen_1 of the measurement period Ssen, the first sensing signal SE1 may be inverted to a high level to turn off the sensing transistor MS_2 in each first pixel PR. The first and second feedback control signals fb1 and fb2 may be maintained at a low level to continuously turn off the first and second feedback switches SW_fb1 and SW_fb2 (e.g., maintain the first and second feedback switches SW_fb1 and SW_fb2 in the off state). The first control signal Φ1 may be maintained at a low level to continuously turn on the first switches SW_1 (e.g., maintain the first switch SW_1 in the on state). The second control signal Φ2 may be maintained at a high level to continuously turn off the second switch SW_2 (e.g., maintain the second switch SW_2 in the off state). The first scan signal S1 may be maintained at a high level to continuously turn off the switch transistor MS_1 (e.g., maintain the switch transistor MS_1 in the off state) in each first pixel PR. In addition, the control signals SH1 and SH2 for activating the first and second CDSes 512a and 512b may be inverted to a high level. Accordingly, the first and second CDSes 512a and 512b may perform correlated double sampling on output signals Vout_1 and Vout_2 of the first and second measurement circuits 511a and 511b, respectively.

The first CDS 512a may receive an output signal having a voltage stored in the output terminal of the first operation amplifier OP_amp_1 up until the sensing transistor MS_2 in the first pixel PR of the first pixel group G1 is turned off. The first CDS 512a may extract a potential difference by comparing the output signal of the first operation amplifiers OP_amp_1 and a pre-stored electric potential corresponding to noise. Therefore, the first CDS 512a can calculate a difference between an electric potential (the sum of a voltage value corresponding to an electric current flowing through the first organic light-emitting diode OLED(R) and a voltage value corresponding to a leakage current in the first pixel PR) of the output signal of the first operation amplifier OP_amp_1 and the electric potential (the voltage value corresponding to the leakage current in the first pixel PR) corresponding to noise. Accordingly, a voltage corresponding to an electric current (i.e., a voltage obtained by removing a voltage corresponding to the leakage current in the first pixel PR from a voltage applied to the output terminal of the first operation amplifier OP_amp_1) flowing through the first organic light-emitting diode OLED(R) in the first pixel group G1 can be measured.

The second CDS 512b may receive an output signal having a voltage stored in the output terminal of the second operation amplifier OP_amp_2 up until the sensing transistor MS_2 in the first pixel PR of the second pixel group G2 is turned off. The second CDS 512b may extract a potential difference by comparing the output signal of the second operation amplifiers OP_amp_2 and a pre-stored electric potential corresponding to noise. Therefore, the second CDS 512b can calculate a difference between an electric potential (the sum of a voltage value corresponding to an electric current flowing through the first organic light-emitting diode OLED(R) and a voltage value corresponding to a leakage current in the first pixel PR) of the output signal of the second operation amplifier OP_amp_2 and the electric potential (the voltage value corresponding to the leakage current in the first pixel PR) corresponding to noise. Accordingly, a voltage corresponding to an electric current (i.e., a voltage obtained by removing a voltage corresponding to the leakage current in the first pixel PR from a voltage applied to the output terminal of the second operation amplifier OP_amp_2) flowing through the first organic light-emitting diode OLED(R) in the second pixel group G2 can be measured. The above-described correlated double sampling can remove a leakage current component contained in the first pixel PR of each of the first and second pixel groups G1 and G2.

Output signals of the first and second CDSes 512a and 512b may be amplified (e.g., amplified to a predetermined size) by the first and second amplifiers 513a and 513b, respectively. The comparator 514 may receive output signals of the first and second amplifiers 513a and 513b, extract a potential difference between the signals, and provide the extracted potential difference to the ADC 520. When the control signal ADC for activating the ADC 520 is inverted to a high level, the ADC 520 may convert an output signal of the comparator 514 into a digital value ADC_OUT and provide the digital value ADC_OUT to the timing controller 300 (see FIG. 1).

Here, if the first pixels PR included in the first and second pixel groups G1 and G2 have been degraded to the same or substantially the same degree, there may be no potential difference (zero potential difference) between the output signals of the first and second amplifiers 513a and 513b. On the other hand, if the first pixels PR included in the first and second pixel groups G1 and G2 have been degraded to different degrees, the potential difference between the output signals of the first and second amplifiers 513a and 513b may not be zero. Accordingly, the timing controller 300 may generate the image data DATA by compensating the image signal R, G, B using the digital value ADC_OUT corresponding to the potential difference. The timing controller 300 can compensate for the degree of degradation by providing the image data DATA to a corresponding pixel.

Referring back to FIG. 6, before the display period E, the first control signal Φ1 may be inverted to a high level, thereby turning on the first switches SW_1. In the display period E, the first through n^{th} scan signals S1 through Sn may be sequentially inverted to a low level to turn on the switch transistor MS_1 included in each first pixel PR. The voltage level of the first power supply terminal ELVDD may be increased from the voltage level of the second power supply terminal ELVSS back to the original voltage level of the first power supply terminal ELVDD. To this end, in the display period E, the power switch may perform a switching operation to connect the signal path between the first electrode of the driving transistor MD and the first power supply terminal ELVDD.

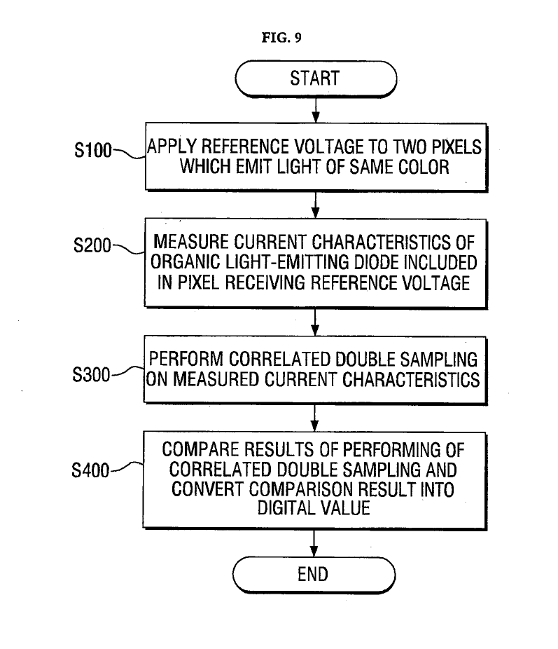

FIG. 9 is a flowchart illustrating a method of driving an organic light-emitting display according to an embodiment of the present invention.

Referring to FIGS. 1, 6 and 9, in the method of driving an organic light-emitting display according to the current embodiment, a reference voltage Vset may be applied to one of first, second, and third pixels PR, PG, and PB included in a first pixel group G1 and one of first, second, and third pixels PR, PG, and PB included in a second pixel group G2 (operation S100). Here, a pixel of the first pixel group G1 which receives the reference voltage Vset and a pixel of the second pixel group G2 which receives the reference voltage Vset may respectively include organic light-emitting diodes OLEDs which emit light of the same or substantially the same color. It will hereinafter be assumed that the first pixel PR included in the first pixel group G1 receives the reference voltage Vset from a first measurement circuit 511a through a switching operation of a multiplexer 600. In the case of the second pixel group G2, the first pixel PR which emits light of the same or substantially the same color as that of light emitted from the first pixel PR included in the first pixel group G1 may receive the reference voltage Vset from a second measurement circuit 511b. Here, the level of the reference voltage Vset may be equal to or substantially equal to or higher than that of a threshold voltage Vth of a first organic light-emitting diode OLED(R) included in the first pixel PR of each of the first and second pixel groups G1 and G2.

In a measurement period Ssen following a reference voltage applying period Sset, current characteristics of the first organic light-emitting diode OLED(R), included in the first pixel PR of each of the first and second pixel groups G1 and G2, may be measured (operation S200). The current characteristics may be a voltage corresponding to an electric current flowing through the first organic light-emitting diode OLED(R). However, if the current characteristics of the first organic light-emitting diode OLED(R) are measured, a leakage current may be generated by a switch transistor MS_1, a driving transistor MD and a sensing transistor MS_2 in the first pixel PR. Ultimately, a voltage measured by each of the first and second measurement circuits 511a and 511b may be expressed as the sum of the voltage corresponding to the electric current flowing through the first organic light-emitting diode OLED(R) and a voltage corresponding to the leakage current. Therefore, the voltage corresponding to the leakage current may be removed by performing correlated double sampling on an output signal of each of the first and second measurement circuits 511a and 511b (operation S300). Then, the two signals which underwent correlated double sampling may be amplified (e.g., amplified to a preset size). The amplified signals may be compared with each other to calculate a voltage difference between them, and the calculated voltage difference may be converted into a signal having a digital value (operation S400).

Embodiments of the present invention provide at least one of the following features.

That is, it is possible to more accurately measure an electric current of each pixel using a simple structure. Accordingly, a difference in degradation between the pixels can be compensated for, thereby realizing uniform image quality.

In addition, current characteristics of two pixels are measured, and a difference between the measured current characteristics is stored. Therefore, a bit depth and a memory size can be reduced.

Furthermore, noise common to two pixels can be removed by concurrently (or simultaneously) measuring characteristics of the two pixels.

However, the features of the present invention are not limited to the one set forth herein. The above and other features of the present invention will become more apparent to one of ordinary skill in the art to which the present invention pertains by referencing the claims and their equivalents.

What is claimed is:

1. An organic light-emitting display comprising:
a display panel comprising:
first and second pixel groups, each group comprising:
first, second, and third pixels configured to emit light of different colors; and
a current measurement unit comprising:
a plurality of current measurement channels connected to the first and second pixel groups by data lines,
wherein each of the current measurement channels comprises:
a first measurement circuit connected to one of the first, second, and third pixels in the first pixel group and configured to measure current characteristics of the connected one of the pixels; and
a second measurement circuit configured to measure current characteristics of one of the first, second, and third pixels, in the second pixel group, which is configured to emit light of the same color as that of light emitted from the one of the pixels connected to the first measurement circuit.

2. The organic light-emitting display of claim 1,
wherein the first measurement circuit comprises:
a first integrator circuit,
wherein the second measurement circuit comprises:
a second integrator circuit,
wherein the first integrator circuit comprises:
a first operation amplifier comprising:
a non-inverting input terminal configured to receive a reference voltage; and
an inverting input terminal connected to one of the first, second, and third pixels in the first pixel group;
a first feedback capacitor connected between the inverting input terminal of the first operation amplifier and an output terminal of the first operation amplifier; and
a first feedback switch connected in parallel to the first feedback capacitor, and
wherein the second integrator circuit comprises:
a second operation amplifier comprising:
a non-inverting input terminal configured to receive the reference voltage; and
an inverting input terminal connected to one of the first, second, and third pixels in the second pixel group;
a second feedback capacitor connected between the inverting input terminal of the second operation amplifier and an output terminal of the second operation amplifier; and
a second feedback switch connected in parallel to the second feedback capacitor.

3. The organic light-emitting display of claim 2,
wherein a level of the reference voltage is equal to or higher than a level of a threshold voltage of an organic light-emitting diode in each of the first, second, and third pixels.

4. The organic light-emitting display of claim 2, wherein each of the current measurement channels further comprises:
a first correlated double sampler (CDS) connected to the output terminal of the first operation amplifier;
a first amplifier connected to the first CDS;
a second CDS connected to the output terminal of the second operation amplifier; and
a second amplifier connected to the second CDS.

5. The organic light-emitting display of claim 1, wherein each of the current measurement channels further comprises:
a comparator configured to compare output signals of the first and second measurement circuits; and
an analog-to-digital converter (ADC) configured to convert an output signal of the comparator into a digital value.

6. The organic light-emitting display of claim 1, further comprising:
a multiplexer connected between the display panel and the current measurement unit.

7. The organic light-emitting display of claim 1, further comprising:
a timing controller comprising:
a latch circuit unit connected to the current measurement channels,
a memory unit connected to the latch circuit unit, and
an operation unit configured to receive an output signal of the latch circuit unit and to generate a compensation value.

8. The organic light-emitting display of claim 1, further comprising:
a data driver comprising:
a plurality of digital-to-analog converters (DACs) connected to the data lines; and
a plurality of first switches connected between the display panel and the DACs.

9. The organic light-emitting display of claim 1,
wherein the first pixel comprises:
a first organic light-emitting diode configured to emit light of a first color,
wherein the second pixel comprises:
a second organic light-emitting diode configured to emit light of a second color,
wherein the third pixel comprises:
a third organic light-emitting diode configured to emit light of a third color, and
wherein the first, second, and third colors are different from one another.

10. An organic light-emitting display comprising:
a display panel comprising:
first and second pixel groups, each group comprising:
first, second, and third pixels configured to emit light of different colors; and
a current measurement channel comprising:
a first measurement circuit configured to apply a reference voltage to one of the first, second, and third pixels in the first pixel group during a reference voltage applying period; and
a second measurement circuit configured to apply the reference voltage to a pixel, among the first, second, and third pixels in the second pixel group, which is configured to emit light of a same color as that of light emitted from the pixel receiving the reference voltage from the first measurement circuit, during the reference voltage applying period,
wherein the current measurement channel is configured to measure current characteristics of an organic light-emitting diode in a pixel connected to the first measurement circuit and to measure current characteristics of an organic light-emitting diode in a pixel connected to the second measurement circuit during a measurement period following the reference voltage applying period.

11. The organic light-emitting display of claim 10,
wherein a level of the reference voltage is equal to or higher than that of a threshold voltage of an organic light-emitting diode in a pixel receiving the reference voltage among the first, second, and third pixels.

12. The organic light-emitting display of claim 10,
wherein the first measurement circuit comprises:
a first integrator circuit configured to measure current characteristics of an organic light-emitting diode in a pixel receiving the reference voltage from the first measurement circuit, during the measurement period;
a first amplifier configured to amplify an output signal of the first integrator circuit; and
a first CDS configured to remove noise from an output signal of the first amplifier, and
wherein the second measurement circuit comprises:
a second integrator circuit configured to measure current characteristics of an organic light-emitting diode in a pixel receiving the reference voltage from the second measurement circuit, during the measurement period;
a second amplifier configured to amplify an output signal of the second integrator circuit; and
a second CDS configured to remove noise from an output signal of the second amplifier.

13. The organic light-emitting display of claim 10, wherein the current measurement channel further comprises:
a comparator configured to compare output signals of the first and second measurement circuits; and
an ADC configured to convert an output signal of the comparator into a digital value.

14. The organic light-emitting display of claim 10, further comprising:
a current measurement unit comprising:
a plurality of current measurement channels comprising the current measurement channel; and
a multiplexer configured to provide signal paths between the current measurement channels and the display panel through a switching operation.

15. The organic light-emitting display of claim 14, further comprising:
a timing controller comprising:
a memory unit configured to store output signals of the current measurement channels and
an operation unit configured to generate a compensation value using the output signals of the current measurement channels.

16. The organic light-emitting display of claim 10, further comprising:
a data driver comprising:
a plurality of DACs which are configured to provide data signals to the display panel through data lines; and
a plurality of first switches which are configured to selectively connect and disconnect signal paths between the display panel and the DACs through switching operations.

17. A method of driving an organic light-emitting display comprising:
first and second pixel groups, each comprising:
first, second, and third pixels which emit light of different colors, the method comprising:
applying a reference voltage to one of the first, second, and third pixels in the first pixel group and to one of the first, second, and third pixels in the second pixel group in a reference voltage applying period; and
measuring current characteristics of an organic light-emitting diode in each pixel receiving the reference voltage among the pixels in the first and second pixel groups in a measurement period following the reference voltage applying period,
wherein the pixel receiving the reference voltage among the first, second, and third pixels in the first pixel group and the pixel receiving the reference voltage among the first, second, and third pixels in the second pixel group have a same color.

18. The method of claim 17,
wherein a level of the reference voltage is equal to or higher than that of a threshold voltage of the organic light-emitting diode in each pixel receiving the reference voltage.

19. The method of claim 17, wherein the organic light-emitting display further comprises:
a current measurement channel comprising:
a first measurement circuit which:
applies the reference voltage to one of the first, second, and third pixels in the first pixel group in the reference voltage applying period, and
measures current characteristics of an organic light-emitting diode in the pixel receiving the reference voltage in the measurement period, and
a second measurement circuit which:
applies the reference voltage to a pixel, which emits light of the same color as that of light emitted from the pixel receiving the reference voltage from the first measurement circuit, among the first, second, and third pixels in the second pixel group in the reference voltage applying period, and
measures current characteristics of an organic light-emitting diode in the pixel receiving the reference voltage from the second measurement circuit in the measurement period.

20. The method of claim 19, further comprising:
performing correlated double sampling on output signals of the first and second measurement circuits;
amplifying the two output signals, which underwent the correlated double sampling;
calculating a difference voltage by comparing the two amplified signals; and
converting the difference voltage into a digital signal.
